(19) United States
(12) Patent Application Publication
(10) Pub. No.: US 2008/0228907 A1
(43) Pub. Date: Sep. 18, 2008

(54) Change detecting method for an it resource configuration

(76) Inventors: Daisuke Iizuka, Yokohama (JP); Yoshimasa Masuoka, Kunitachi (JP)

Correspondence Address: MCDERMOTT WILL & EMERY LLP, 600 13TH STREET, N.W., WASHINGTON, DC, 20005-3096, US

(21) Appl. No.: 11/902,363

(22) Filed: Sep. 20, 2007

(30) Foreign Application Priority Data
Mar. 13, 2007 (JP) 2007-064018

(51) Int. Cl. G06F 15/173

(52) U.S. Cl. 709/223; 709/224

(57) ABSTRACT

To collect configuration information of an application server, there is provided a change detecting method of detecting a change in configuration information of an application server installed in a computer system, the computer system including: one or more of the application servers; a management server for controlling the application servers; and a configuration management server for managing configuration information of the application servers, the change detecting method including: obtaining a packet transmitted from the management server to at least one of the application servers; specifying at least one of the application servers which receives the obtained packet and at least one of resources on the application servers, with reference to the configuration information held by the configuration management server by using the obtained packet; and determining whether configuration information of the resources on the application servers is likely to be changed by an operation of the specified resource.

### CLAIM OF PRIORITY

The present application claims priority from Japanese patent application JP 2007-64018 filed on Mar. 13, 2007, the content of which is hereby incorporated by reference into this application.

### BACKGROUND OF THE INVENTION

This invention relates to a system for collecting configuration information of a server and a change detecting method for applying the collected configuration information to a system held by a configuration management mechanism.

There is an application operating environment including an application server group and an client group connected to a network, in which a program is executed on an application server to provide service to a client. In this environment, in order to provide an administrator with configuration information on a configuration of the application servers in operation, it is necessary to collect, by a configuration management server, a list of programs operated on each of the application servers, information on resources used by the programs, and setting information of the programs. Also, the setting information thus collected needs to be held by the configuration management server.

Examples of a technology of collecting configuration information include: a technology of collecting configuration information without operating an agent on the application servers; and a technology of collecting configuration information by operating an agent on the application servers. According to the technology of collecting configuration information without operating an agent on the application servers, the administrator first logs into each of the application servers from a management server by a command such as telnet or ssh. Then, some of the commands (such as ps) generally installed in the application server to which the administrator has logged in are executed on the application server, whereby configuration information is collected (see “IBM Tivoli Application Dependency Discovery Manager”). Meanwhile, according to the technology of collecting configuration information by operating an agent, the agent is installed in each of the application servers, whereby configuration information is collected.

However, there has been a problem that it takes a lot of trouble with management work for installing an agent to all the application servers. In view of this, in recent years, the technology of collecting configuration information without operating an agent is drawing attention. According to the technology of collecting configuration information without operating an agent, a configuration management server periodically visits the application servers to collect configuration information. The configuration information thus collected is compared with previous configuration information, which is configuration information before being changed, and stored in the configuration management server, to thereby enable an administrator to find out what kind of change has been made to the configuration information in the application servers.

Also, JP 2006-11683 A discloses a technology of obtaining a packet on a network and analyzing contents of the packet. According to the technology disclosed in JP 2006-11683 A, first, a communication packet exchanged between application programs operating on application servers is obtained. Then, a payload of the packet thus obtained is analyzed and a model is created, to thereby form a transaction model. When a packet following the transaction model is observed, a processing state of a transaction is analyzed.

In the case of collecting configuration information by the configuration management server which periodically visits the application servers, it generally takes time to collect configuration information. For example, even when an administrator wants to know the contents of configuration information when the configuration information of one of the application servers has been changed, it may take time to collect the configuration information because the configuration management server periodically visits all the application servers. Accordingly, it is impossible to instantly provide the configuration information to the administrator. This problem can be solved by instructing the configuration management server to collect the configuration information preferentially from the corresponding application server. However, there is a problem that it is still impossible to instantly provide the configuration information to the administrator, for example, in a case where the operator has unintentionally instructed configuration change by operation mistake or the like, in a case where the administrator has failed to give an instruction to collect the configuration information, or in a case where another administrator has maliciously changed the configuration information and does not give an instruction to collect the configuration information intentionally.

This invention has been made to solve the above-mentioned problem, and it is an object of the invention to provide a change detecting method capable of determining, by a management server, whether configuration information of an application server may have been changed or not, and of collecting, by the configuration management server, when it has been determined that the configuration information may have been changed, the configuration information from the corresponding application server.

### SUMMARY OF THE INVENTION

A representative aspect of this invention is as follows. That is, there is provided a change detecting method of detecting a change in configuration information of an application server installed in a computer system, the computer system including: one or more of the application servers; a management server for controlling the application servers; and a configuration management server for managing configuration information of the application servers. The change detecting method comprising: a first step of obtaining a packet transmitted from the management server to at least one of the application servers; a second step of specifying at least one of the application servers which receives the obtained packet and at least one of resources on the application servers, with reference to the configuration information held by the configuration management server by using the obtained packet; and a third step of determining whether configuration information of the resources on the application servers is likely to be changed by an operation of the specified resource.

According to an embodiment of this invention, contents of a network packet transmitted from the management server to at least one of the application servers is analyzed, and it is determined whether configuration information is likely to be changed by an operation from the management server. Then, in a case where it has been determined that the configuration information is likely to be changed, the configuration information is collected from the corresponding application server. In this manner, it is possible to immediately find out what kind of change has been made to the configuration information. Also, a resource to be changed in configuration is specified and the configuration information is collected only from the specified resource, to thereby avoid using excess resources for collecting the configuration information.

### BRIEF DESCRIPTION OF THE DRAWINGS

The present invention can be appreciated by the description which follows in conjunction with the following figures, wherein:

FIG. 1 is a configuration diagram showing a change detecting device in accordance with a first embodiment of this invention;

FIG. 2 is a configuration diagram showing a management server in accordance with the first embodiment of this invention;

FIG. 3 is a configuration diagram showing a server type table in accordance with the first embodiment of this invention;

FIG. 4 is a configuration diagram showing a configuration information table in accordance with the first embodiment of this invention;

FIG. 5 is a configuration diagram showing a unchanged program table in accordance with the first embodiment of this invention;

FIG. 6 is a configuration diagram showing a changing program definition table in accordance with the first embodiment of this invention;

FIG. 7 is a diagram showing a format of a packet in accordance with the first embodiment of this invention;

FIG. 8 is a flowchart of a change detecting process performed by a configuration management server in accordance with the first embodiment of this invention;

FIG. 9 is a diagram showing a format of a simple network management protocol (SNMP) packet used in a third embodiment of this invention;

FIG. 10 is a flowchart of a change detecting process performed by the configuration management server in accordance with the third embodiment of this invention;

FIG. 11 is a configuration diagram showing a changing SNMP definition table in accordance with a fourth embodiment of this invention;

FIG. 12 is a configuration diagram showing a format of an WS-Management packet in accordance with a fifth embodiment of this invention;

FIG. 13 is a configuration diagram showing a changing WS-Management definition table in accordance with a sixth embodiment of this invention.

### DETAILED DESCRIPTION OF THE PREFERRED EMBODIMENTS

Hereinafter, embodiments of this invention are described with reference to the accompanying drawings.

### First Embodiment

First, a change detecting device according to a first embodiment of this invention is described.

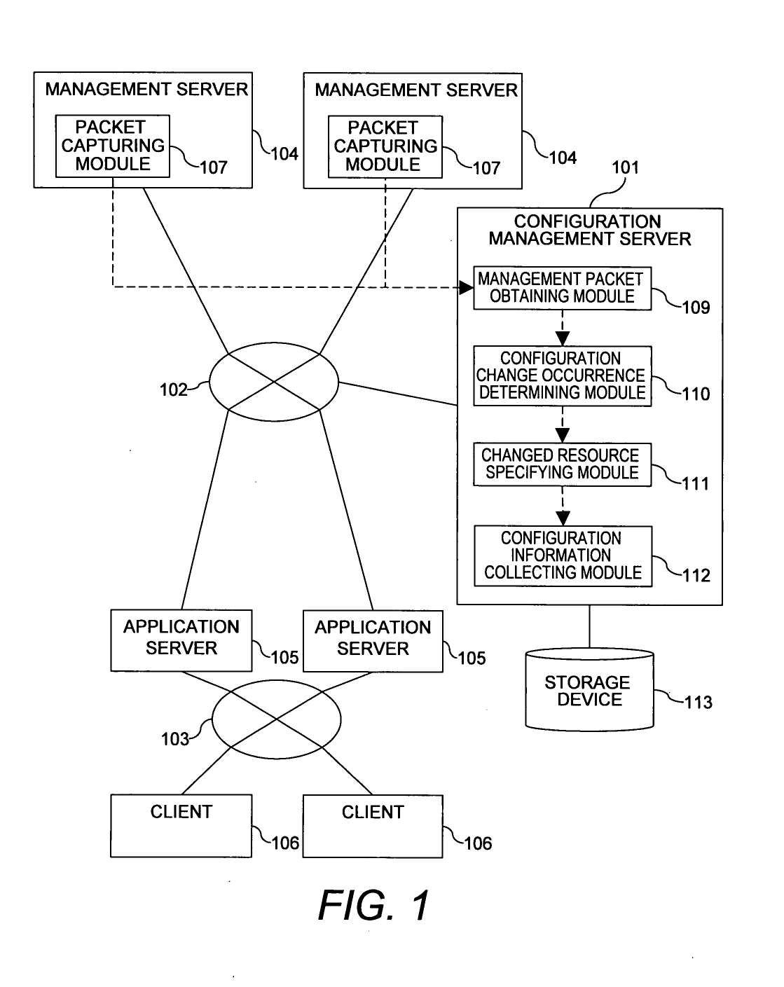

FIG. 1 is a configuration diagram of the change detecting device according to the first embodiment of this invention. The change detecting device includes management servers 104, a management network 102, application servers 105, an application network 103, clients 106, and a configuration management server 101.

The management servers 104 each control or manage statuses of the application servers 105 and clients 106, and include a packet capturing module 107. The packet capturing module 107 monitors packets flowing through the management network 102. The packet capturing module 107 may be implemented by storing a program in a memory of the management server 104 and executing the program by a processor of the management server 104. Alternatively, the packet capturing module 107 may be formed as an integrated circuit and implemented by hardware.

The management network 102 has the management servers 104, the application servers 105, and the configuration management server 101 connected thereto. The application servers 105 each provides application service to each of the clients 106. The application network 103 has the clients 106 and the application servers 105 connected thereto.

The numbers of the management servers 104, the application servers 105, and the clients 106 are all illustrated as two, but the numbers may be one or more. Also, the application network 103 and the management network 102 may be the same network.

The configuration management server 101 includes a management packet obtaining module 109, a configuration change occurrence determining module 110, a changed resource specifying module 111, and a configuration information collecting module 112. The configuration management server 101 has a storage device 113 connected thereto, but the storage device 113 may be provided inside the configuration management server 101.

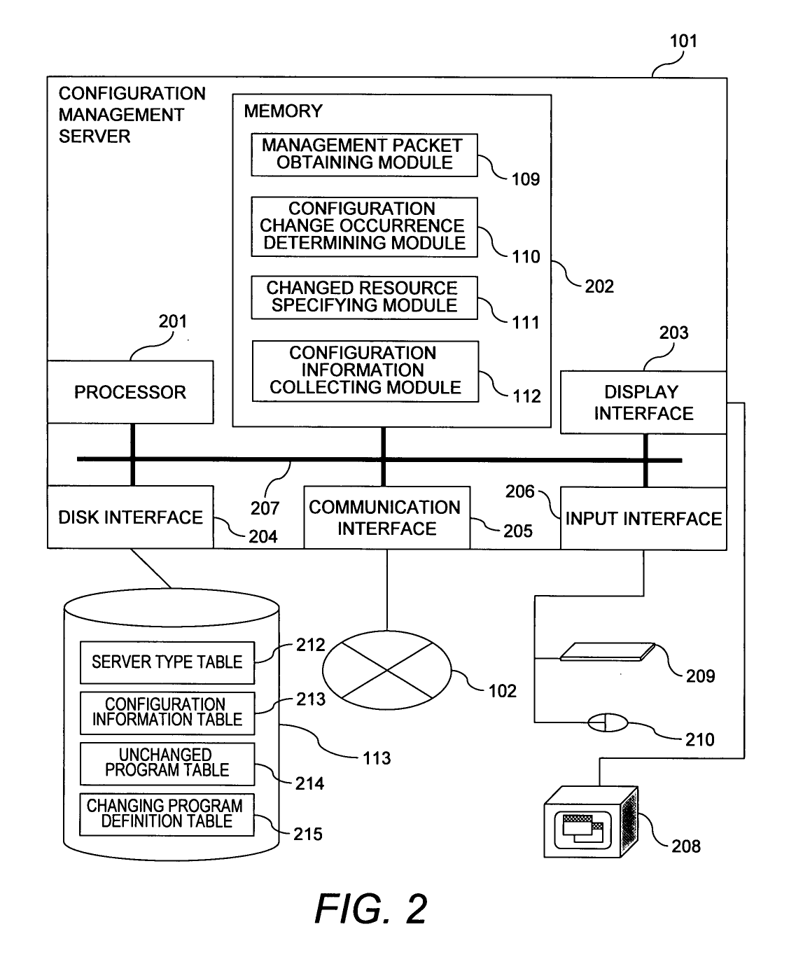

The configuration management server 101 obtains packets flowing through the management network 102. The packets thus obtained are each analyzed for configuration information thereof. Then, based on the packets thus analyzed, it is determined whether the configuration information in one of the application server 105 may have been changed or not. According to the first embodiment of this invention, a program name of a program operating on the management server 104, a protocol type indicating which one of transmission control protocol (TCP) and user datagram protocol (UDP) is used by the program for communication, and a port numbers are used as a group to form the configuration information. Further, the configuration information may also include setting information used by a program, a communication topology between different application servers 105, or hardware information of the configuration management server 101. The configuration management server 101 is described in detail with reference to FIG. 2.

The management packet obtaining module 109 obtains packets flowing through the management network 102. Of the packets thus obtained, a packet to be transmitted to one of the application servers 105 from the management server 104 is selected, and the packet is transferred to the configuration change occurrence determining module 110.

The management packet obtaining module 109 may obtain packets to be transmitted from a mirror port of a network switch forming the management network 102. Alternatively, the packet capturing module 107 of each of the management servers 104 transmits a packet, which is output on the management network 102 by each of the management servers 104, to the management packet obtaining module 109, whereby the management packet obtaining module 109 may obtain the packet. Further, the configuration management server 101 may be provided as a router connecting a network between the management servers 104 and the application servers 105, and the management packet obtaining module 109 may obtain packets transmitted from the management servers 104 to the application servers 105.

The configuration change occurrence determining module 110 analyzes each of the packets thus obtained, to thereby determine whether the configuration of each of the application servers 105 is likely to be changed or not. In a case where it is determined that the configuration is likely to be changed, the configuration change occurrence determining module 110 transfers a corresponding packet to the changed resource specifying module 111.

The changed resource specifying module 111 analyzes the packet thus received, to thereby determine whether it is possible to specify one of the programs on the corresponding one of the application servers 105, the program having configuration information to be changed. In a case where the program can be specified, the changed resource specifying module 111 instructs the configuration information collecting module 112 to collect configuration information only from the corresponding program on the application server 105. On the other hand, in a case where the program cannot be specified, the changed resource specifying module 111 instructs the configuration information collecting module 112 to collect configuration information from all the programs on the application server 105 which is a destination of the packet.

The configuration information collecting module 112 collects configuration information from the resource specified by the changed resource specifying module 111, and stores the configuration information in the storage device 113.

The management servers 104 may each include the management packet obtaining module 109, and the configuration management server 101 may include only the configuration change occurrence determining module 110, the changed resource specifying module 111, and the configuration information collecting module 112. In this case, the management server 104 transfers only the packets transmitted from the management servers 104 to the application servers 105. Alternatively, all the processing modules of the configuration management server 101 may be provided to each of the management servers 104.

FIG. 2 is a configuration diagram of the configuration management server 101 according to the first embodiment of this invention.

The configuration management server 101 includes a processor 201, a memory 202, a display interface 203, a disk interface 204, a communication interface 205, and an input interface 206, which are connected to one another through a bus 207.

The processor 201 executes a program stored in the memory 202. The memory 202 stores programs to be processed by the management packet obtaining module 109, the configuration change occurrence determining module 110, the changed resource specifying module 111, and the configuration information collecting module 112. According to the first embodiment of this invention, the programs to be processed are implemented by being executed by the processor 201, but the programs may also be formed as an integrated circuit and implemented by hardware.

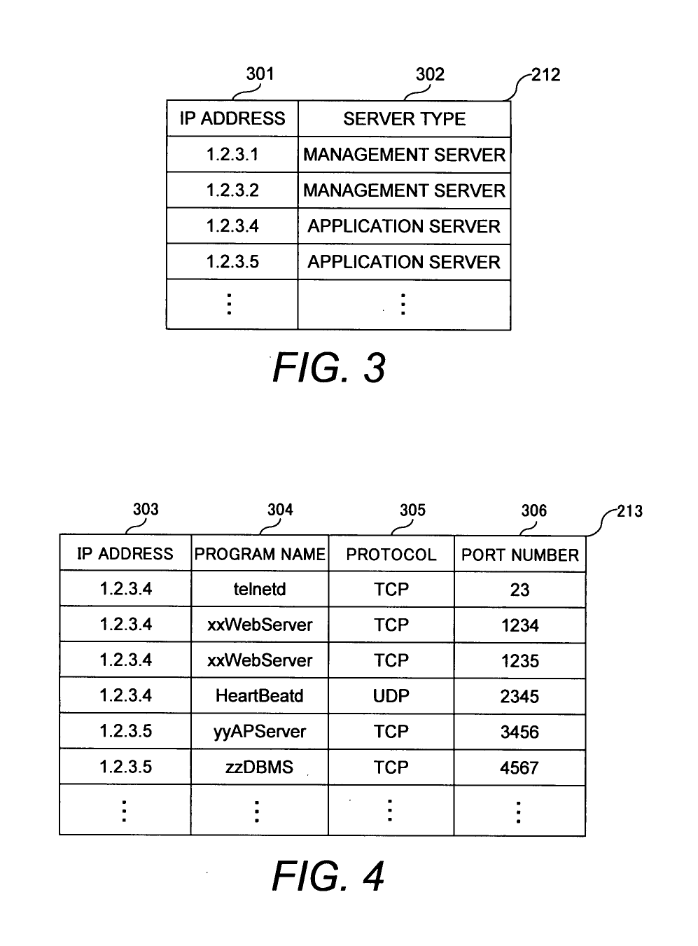

The display interface 203 is connected to a screen display device 208. The disk interface 204 is connected to the storage device 113 such as a hard disk. The storage device 113 includes a server type table 212, a configuration information table 213, an unchanged program table 214, changing program definition table 215. Those tables are described in detail with reference to FIGS. 3 to 6. Further, the communication interface 205 is connected to the management network 102. The input interface 206 is connected to a keyboard 209 and a mouse 210.

FIG. 3 shows the server type table 212 according to the first embodiment of this invention.

The server type table 212 is used to specify one of the management servers 104 or one of the application servers 105, based on an IP address.

The server type table 212 stores therein IP addresses 301 and server types 302. The IP addresses 301 are IP addresses of the management servers 104 or the application servers 105 connected to the management network 102. The server types 302 are information for identifying whether the server is the management server 104 or the application server 105.

FIG. 4 shows the configuration information table 213 according to the first embodiment of this invention.

The configuration information table 213 is used to specify a program based on an IP address, a protocol, and a port number.

The configuration information table 213 stores therein IP address 303, program name 304, protocol 305, and port number 306.

The IP address 303 is an IP address of the each management server 104 and the each application server 105 connected to the management network 102. The program name 304 is name of program operating on one of the application server 105 corresponding to an IP address 303. The protocol 305 is name of protocol (TCP or UDP) each used for transmitting and receiving a packet by each of the application server 105 for operating the program. The port number 306 are number of ports each used for transmitting and receiving a packet by each of the application server 105 for operating the program.

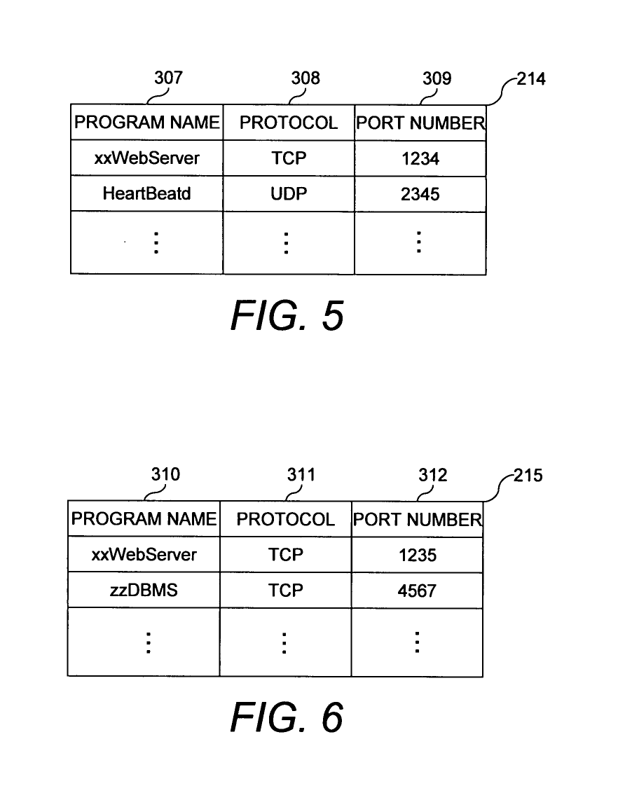

FIG. 5 shows the unchanged program table 214 according to the first embodiment of this invention.

The unchanged program table 214 is used for specifying a name of a program whose configuration information is not to be changed, based on a protocol and a port number.

The unchanged program table 214 stores therein program names 307, protocols 308, and port numbers 309.

The program names 307 are program names of programs each having configuration information not to be changed in a case where one of the management server 104 communicates with the program operating on one of the application servers 105 by accessing a certain port of TCP or UDP when the management server 104 transmits a packet to the application server 105.

The protocols 308 are information on protocols each used for transmitting and receiving a packet when operating the program. The port numbers 309 are port numbers of ports each used for transmitting and receiving a packet for operating the program.

FIG. 6 shows the changing program definition table 215 according to the first embodiment of this invention.

The changing program definition table 215 is used for specifying a program name defining a program whose configuration information is to be changed, based on a protocol and a port number.

The changing program definition table 215 stores therein program names 310, protocols 311, and port numbers 312.

The program names 310 are program names defining programs which are exclusively subjected to change of configuration information. Specifically, each of the programs may not be subjected to change of configuration information in a case where one of the management servers 104 communicates with the program operating on one of the application server 105 by accessing a certain port of TCP or UDP when the management server 104 transmits a packet to the application server 105.

The protocols 311 are information on protocols each used for transmitting and receiving a packet when operating the program. The port numbers 312 are port numbers of ports each used for transmitting and receiving a packet for operating the program.

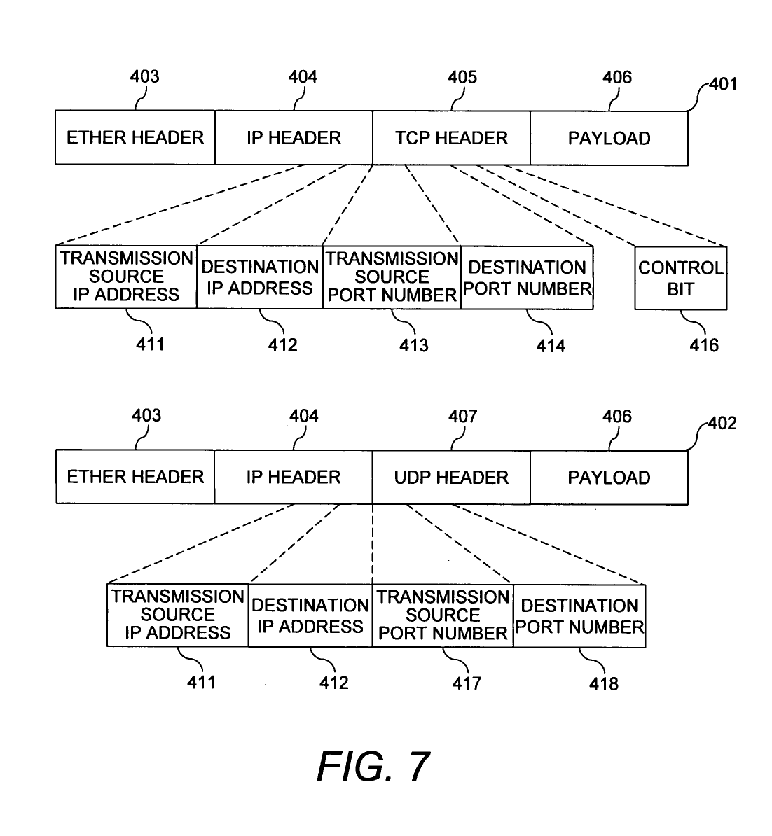

FIG. 7 shows a format of a packet according to the first embodiment of this invention.

The management packet obtaining module 109 obtains a TCP packet 401 or a UDP packet 402.

The TCP packet 401 includes an Ether header 403, an IP header 404, a TCP header 405, and a payload 406.

The Ether header 403 is described in detail in IEEE 802.3. The IP header 404 includes a transmission source IP address 411 and a destination IP address 412. The IP header 404 is described in detail in RFC 791. The TCP header 405 includes a transmission destination port number 413, a destination port number 414, and a control bit 416. The TCP header 405 is described in detail in RFC 793. The payload 406 includes data such as contents of configuration information.

The UDP packet 402 includes the Ether header 403, the IP header 404, a UDP header 407, and the payload 406.

The UDP header 407 includes a transmission port number 417 and a destination port number 418. The UDP header is described in detail in RFC 768.

The management packet obtaining module 109 refers to the formats of the TCP packet 401 and the UDP packet 402, to thereby obtain the transmission source IP address 411, the destination IP address 412, the protocol, the transmission source port number 413, the destination port number 414, the control bit 416, and the payload 406 of the packet.

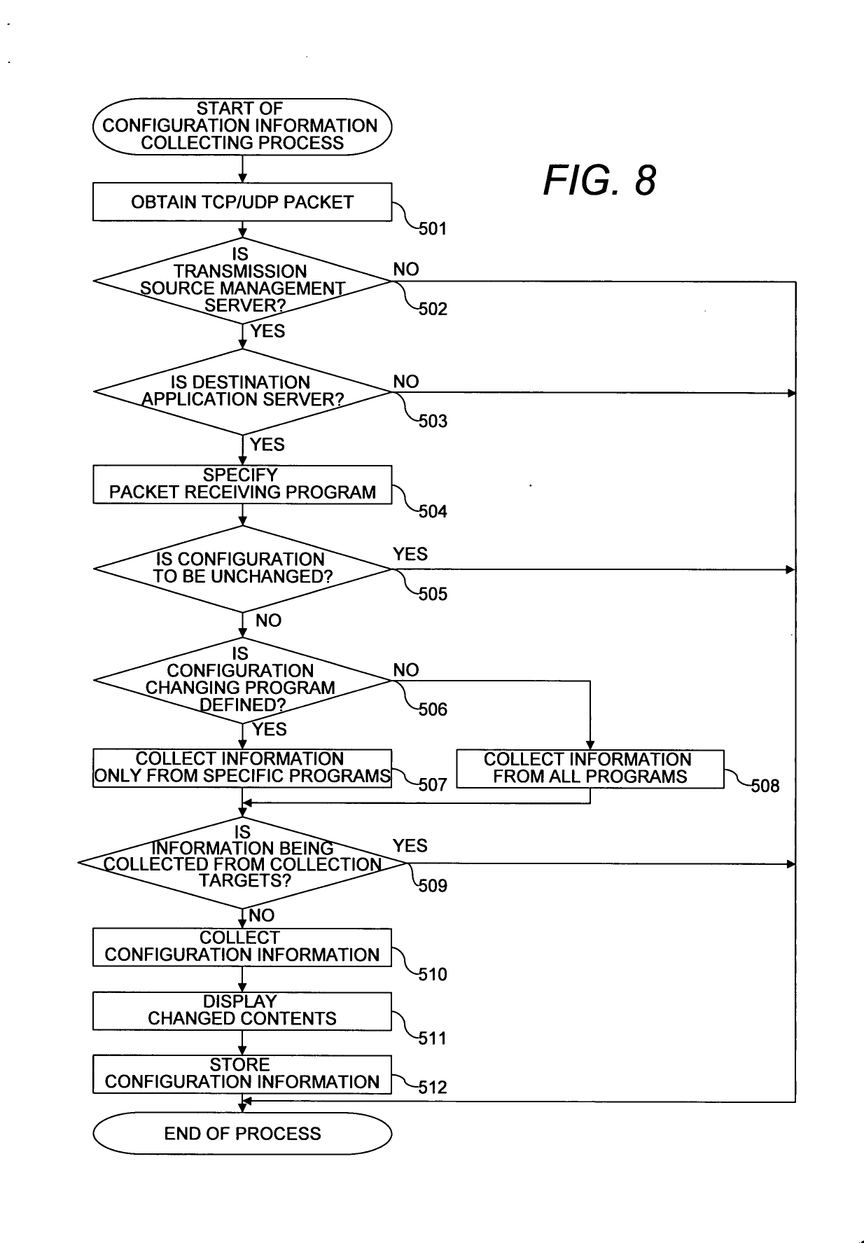

FIG. 8 is a flowchart of a change detecting process performed by the configuration management server 101 according to the first embodiment of this invention.

The change detecting process is started when one of the management servers 104 and one of the application servers 105 exchange a packet through the management network 102.

First, the management packet obtaining module 109 obtains a packet of TCP or UDP from the network switch on the management network 102 or from the packet capturing module 107 on the management server 104 (Step 501).

Next, the management packet obtaining module 109 compares the transmission source IP address of the obtained packet with the IP address 301 stored in the server type table 212. As a result of the comparison, in a case where the server type 302 is of the management server 104, the change detecting process is continued. On the other hand, in a case where the server type 302 is of the application server 105, the change detecting process is ended (Step 502).

Next, the management packet obtaining module 109 compares the destination IP address of the obtained packet with the IP address 301 stored in the server type table 212. As a result of the comparison, in a case where the server type 302 is of the application server 105, the change detecting process is continued. On the other hand, the server type 302 is of the management server 104, the change detecting process is ended (Step 503).

Next, the management packet obtaining module 109 compares the destination IP address, a protocol, and a destination port number of the obtained packet with the IP address 303, the protocol 305, and the port number 306 stored in the configuration information table 213. As a result of the comparison, a program name 304 corresponding to the IP address 303, the protocol 305, and the port number 306 can be obtained. When the program name is obtained, a program for receiving the packet is specified (Step 504).

Next, the configuration change occurrence determining module 110 compares the program name obtained in Step 504 and the protocol and the destination port number of the obtained packet with the program name 307, the protocol 308, and the port number 309 stored in the unchanged program table 214. As a result of the comparison, in a case where the unchanged program table 214 includes a corresponding record, it is determined that the configuration information is not to be changed by the obtained packet, and the change detecting process is ended. On the other hand, in a case where the unchanged program table 214 does not include a corresponding record, it is determined that the configuration information may be changed, and the change detecting process is continued (Step 505).

In the process of Step 505, in a case where the obtained packet is a TCP packet, the control bit 416 included in the TCP header 405 is referred to. In a case where at least one of the bits of the flags indicating SYN, FIN, and RST of the control bit 416 thus referred to includes “1”, it is determined that the configuration information is not to be changed because the obtained packet is used for communication control of TCP, and the change detecting process may be ended. Also, in a case where the size of the payload 406 of the obtained packet is “0”, it is determined that the configuration information is not to be changed by the obtained packet, and the change detecting process may be ended.

Next, the changed resource specifying module 111 compares the program name obtained in Step 504, and the protocol and the destination port number of the obtained packet with the program name 310, the protocol 311, and the port number 312 stored in the changing program definition table 215. Based on a result of the comparison, it is determined whether it is possible or not to define a program whose configuration information is to be changed (Step 506). Step 505 is executed in prior to Step 506 to reduce the number of packets to be subjected to the determination in Step 506, to thereby reduce processing load in the processes in and after Step 506.

Next, in a case where the changing program definition table 215 includes a corresponding record in Step 506, the changed resource specifying module 111 instructs the configuration information collecting module 112 to collect configuration information only from programs corresponding to the program names obtained in Step 504, of the programs operating on the application server 105 indicated by the destination IP address of the obtained packet (Step 507).

On the other hand, in a case where the changing program definition table 215 does not include a corresponding record, the changed resource specifying module 111 instructs the configuration information collecting module 112 to collect configuration information from all the programs operating on the application server 105 indicated by the destination IP address of the obtained packet (Step 508).

Next, the configuration information collecting module 112 determines whether configuration information is being collected from the target programs, based on whether an application for collecting configuration information is operating on the application server 105 indicated by the destination IP address of the obtained packet. In a case where configuration information is being collected, the change detecting process is ended. In other words, in a case where configuration information is being collected, it is determined that the configuration information does not need to be collected from the application server 105. On the other hand, in a case where configuration information is not being collected, the change detecting process is continued (Step 509).

Next, the configuration information collecting module 112 collects configuration information from programs on the designated application server 105 according to the contents of the instruction given by the changed resource specifying module 111 (Step 510).

Then, the configuration information collecting module 112 compares the configuration information thus collected with the configuration information stored in the configuration information table 213. As a result of the comparison, the contents of the changed configuration information is displayed on the screen display device 208 (Step 511).

Lastly, the configuration information thus collected is stored in the configuration information table 213 (Step 512). Then, the configuration information collecting module 112 ends the process.

It should be noted that, in Step 511, the collected configuration information may directly be displayed instead of the changed configuration information, or the contents of the changed configuration information and the collected configuration information may be displayed. The configuration information may be stored in the storage device 113 for example, in a file format, or may be notified to the management server 104 through a network, rather than being displayed on the screen display device 208.

In a case where the configuration information collecting module 112 is processing an operation to periodically collect configuration information from all the application servers 105, the execution of the entire process of FIG. 8 may be stopped.

The first embodiment of this invention enables the management server 104 to determine whether configuration information of the programs operating on each of the application servers 105 may have been changed or not. In a case where it has been determined that the configuration information may have been changed, configuration information of the entire programs operating on the corresponding application server 105 or configuration information of a specific program operating on the corresponding application server 105 is collected, which allows the application administrator to be informed of what kind of change has been made to the configuration information.

Apart from the process according to the first embodiment of this invention, the configuration information collecting module 112 may periodically collect configuration information of the application servers 105. When the configuration information of the application servers 105 is periodically collected, an administrator of an application can be informed what kind of change has been made to the configuration information even in a case where the configuration information has been changed without using the application network 103, for example, in a case where the administrator of the application has changed the configuration information by using a console of one of the application servers 105.

### Second Embodiment

According to the first embodiment of this invention, a port number included in a packet is used for detecting a change in the configuration information. On the other hand, according to a second embodiment of this invention, a service name is used in place of the port number.

Specifically, in the configuration information table 213, a service name is defined in place of the port number.

The service name includes a service name uniquely corresponding to the port number 306 on the application server 105 indicated by the IP address 301.

In OS such as Unix, the service name corresponding to the port number is obtained with reference to the “/etc/services file”. Further, in the unchanged program table 214, a service name corresponding to the port number is defined in place of the port number 309. Similarly, in the changing program definition table 215, a service name corresponding to the port number is defined, in place of the port number 312.

Then, in the change detecting process, the management packet obtaining module 109 obtains a service name in Step 504 of FIG. 8. Also, in Step 505, the configuration change occurrence determining module 110 compares the service name obtained in Step 504 with the service name in the unchanged program table 214, instead of comparing the destination port number of the obtained packet with the port number in the unchanged program table 214. Further, in Step 506, the changed resource specifying module 111 compares the service name obtained in Step 504 with the service name in the changing program definition table 215, instead of comparing the destination port number of the obtained packet with the port number in the changing program definition table 215.

According to the second embodiment of this invention, even in a case where the port number used in a program has been changed from a default value, it is possible to determine, through the operation from the management server 104, whether the configuration information of a program operating on a specific one of the application servers 105 is highly likely to have been changed. Further, in a case where it is determined that the configuration information is highly likely to have been changed, the configuration information of all programs operating on the specific application server 105 or of a specific program operating on the specific application server 105 is collected, which allows the application administrator to be informed of what kind of change has been made to the configuration information.

### Third Embodiment

According to a third embodiment of this invention, the determining process is changed such that a change in configuration information can be detected in a case where a packet to be obtained is an SNMP packet.

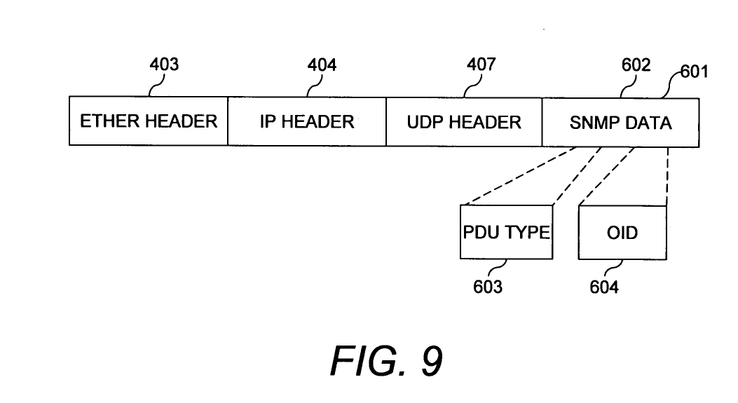

FIG. 9 shows a format of a simple network management protocol (SNMP) packet used in the third embodiment of this invention. The SNMP packet is described in detail in RFC 1157.

The SNMP packet 601 includes SNMP data 602 in the payload 406 of the UDP packet 402. The SNMP data 602 includes a PDU type 603 and an OID 604.

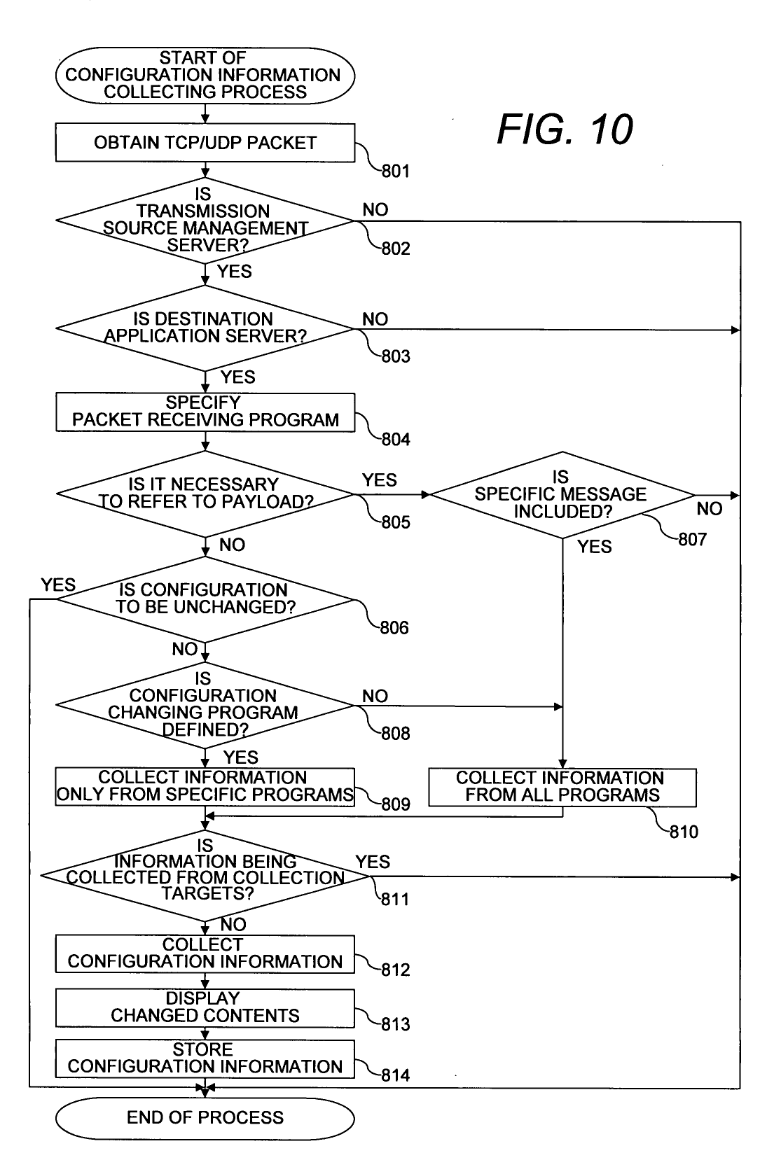

FIG. 10 is a flowchart of a change detecting process performed by the configuration management server 101 according to the third embodiment of this invention.

The change detecting process is started, as in the first embodiment of this invention, when one of the management servers 104 and one of the application servers 105 exchange a packet through the management network 102.

The processes performed in Step 801 to Step 804 are similar to those in Step 501 to Step 504 of the first embodiment of this invention shown in FIG. 8.

After a program for receiving the packet is specified in Step 804, it is determined, with reference to the protocol and the port number of the packet, whether the payload 406 of the packet needs to be referred to (Step 805).

Specifically, in a case where the received packet is the UDP packet 402 and has the destination port number of 161, it is determined that the packet is the SNMP packet. Then, it is determined that the payload 406 of the packet that has been determined as the SNMP packet needs to be referred to.

In a case where it has been determined in Step 805 that the payload 406 does not need to be referred to, the process proceeds to Step 806, and follows the processes similar to the processes performed in and after Step 505 of the first embodiment of this invention shown in FIG. 8.

As regards the SNMP packet having the payload 406 that has been determined to be referred to, it is determined whether the payload 406 of the SNMP packet includes a specific message (Step 807).

Specifically, in a case where the payload 406 of the SNMP packet does not include a SetRequest message, the change detecting process is ended because configuration information is not to be changed. On the other hand, in a case where the payload 406 of the SNMP packet includes the SetRequest message, it is determined that configuration information is highly likely to be changed. Also, configuration information collection targets includes all programs operating on the application server 105, and the process proceeds to Step 810. In order to check whether the payload 406 of the SNMP packet includes the SetRequest message, the protocol data units (PDU) type 603 included in the SNMP packet may be checked.

Next, the configuration information collecting module 112 is instructed to collect configuration information form all the programs operating on the application server 105 (Step 810).

The processes performed in Step 811 to Step 814 thereafter are similar to those in Step 509 to Step 512 of the first embodiment of this invention shown in FIG. 8.

The third embodiment of this invention enables the management server 104 to determine whether the configuration information of a program operating on a specific application server 105 is highly likely to have been changed, by using SNMP. Then, in a case where it is determined that the configuration information is highly likely to have been changed, configuration information of all the programs operating on a specific one of the application servers 105 is collected, which allows the application administrator to be informed of what kind of change has been made to the configuration information.

### Fourth Embodiment

A description is given of a fourth embodiment of this invention, which is a partial modification of the third embodiment of this invention.

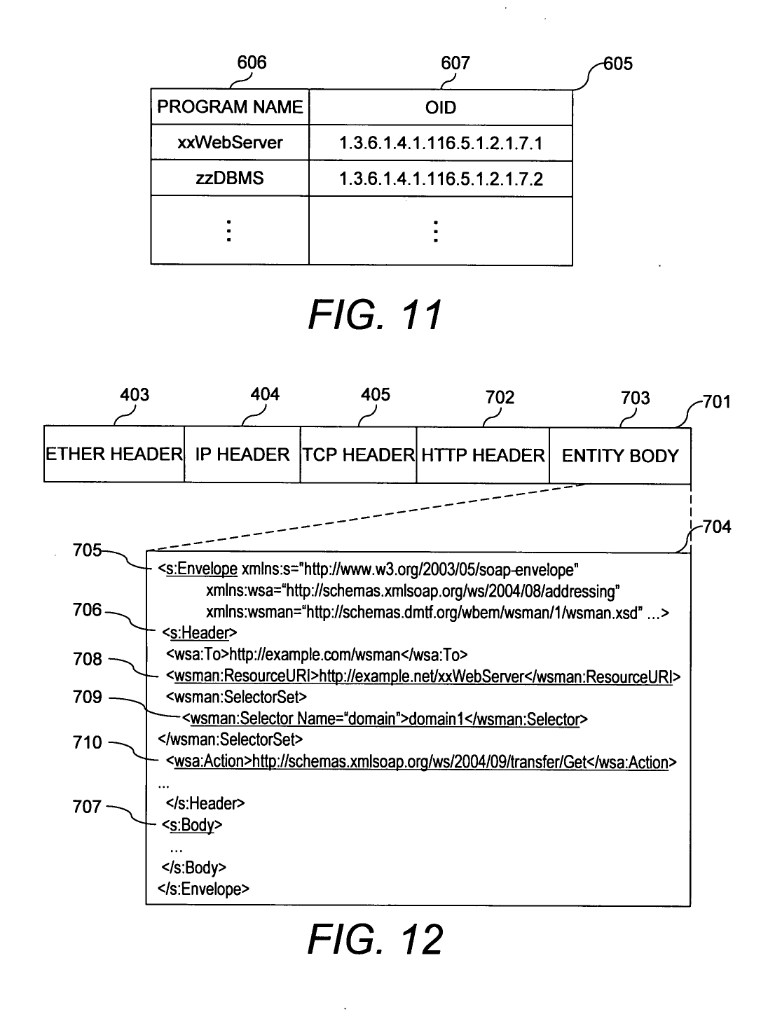

FIG. 11 shows a changing SNMP definition table 605 stored in the storage device 113 to be used in the fourth embodiment of this invention.

The changing SNMP definition table 605 is used for specifying a program name defining a program whose configuration information is to be changed, based on OID.

The changing SNMP definition table 605 stores therein program names 606 and OIDs 607.

The program names 606 are program names defining, from among the programs whose configuration information to be changed by the SetRequest message included in the SNMP packet, programs which are exclusively subjected to change of configuration information.

The OIDs 607 are object identifiers (OIDs) of programs which are subjected to change due to the SetRequest message included in the SNMP packet.

According to the fourth embodiment of this invention, in a case where the SNMP packet includes the SetRequest message in Step 807 of the third embodiment of this invention, the process proceeds to Step 808.

Next, the contents of the payload 406 of the SNMP packet is analyzed. The OID is obtained from the analyzed payload 406. The obtained OID is compared with the OID 607 stored in the changing SNMP definition table 605 (Step 808).

In a case where the changing SNMP definition table 605 includes a corresponding OID, the configuration information collecting module 112 is instructed to collect configuration information only from programs matching with the obtained OID which is included in the changing SNMP definition table 605, of the programs operating on the application server 105 to be a destination of the packet (Step 809). On the other hand, in a case where the changing SNMP definition table 605 includes no corresponding OID, the configuration information collecting module 112 is instructed to collect configuration information from all the programs operating on the application server 105 to be a destination of the packet (Step 810).

In comparing the OID, in a case where the OID obtained from the SNMP packet forms a subtree of the OID 607 in the changing SNMP definition table 605, it may be regarded that the OID matches with the OID 607.

The processes performed in Step 811 to Step 814 thereafter are similar to those in Step 509 to Step 512 of the first embodiment of this invention shown in FIG. 8.

The fourth embodiment of this invention enables the management server 104 to determine whether the configuration information of a program operating on a specific one of the application servers 105 is highly likely to have been changed, by using SNMP. Then, in a case where it is determined that the configuration information is highly likely to have been changed, configuration information of a specific program operating on the specific application server 105 is collected, which allows the application administrator to be informed of what kind of change has been made to the configuration information.

### Fifth Embodiment

According to a fifth embodiment of this invention, the determining process is changed such that a change in configuration information can be detected in a case where a packet to be obtained includes a SOAP message.

FIG. 12 shows a format of an HTTP packet which includes the SOAP message of WS-Management used in this embodiment. The WS-Management is described in WS-Management standard of the Distributed Management Task Force (DMTF). The SOAP message is described in the World Wide Web Consortium (W3C) Recommendation on SOAP Version 1.2.

An HTTP packet including the SOAP message of WS-Management includes an Ether header 403, an IP header 404, a TCP header 405, an HTTP header 702, and an entity body 703.

In FIG. 12, the entity body 703 of the HTTP packet 701 includes the SOAP message, but the SOAP message may be included in another protocol such as Simple Mail Transfer Protocol (SMTP). The HTTP is described in RFC 2616. Also, the SMTP is described in RFC 821. The HTTP header 702 is described in RFC 2068.

The entity body 703 includes a SOAP message detail 704. The SOAP message detail 704 is obtained from a character string describing the contents of the SOAP message which is partially omitted. The SOAP message 704 is formed of XML text having a SOAP Envelope element 705 as a route. The XML is described in the W3C Recommendation on XML version 1.1.

The SOAP Envelope element 705 includes a SOAP Header element 706 and a SOAP body element 707. The SOAP Header element 706 includes a ResourceURI element 708, 0 or more of Selector elements 709, and an Action element 710. The ResourceURI element 708 and the Selector element 709 are defined in WS-Management. The Action element 710 is defined in Web Services Addressing (WS-Addressing). The WS-Addressing is described in WS-Addressing of the W3C.

In a case where the Action element 710 includes http:// . . . /transfer/Get as shown, the SOAP message is a resource operation Get of Web Service Transfer (WS-Transfer). The WS-Transfer is described in WS-Transfer of the W3C.

The process of the fifth embodiment of this invention follows, similarly to the third embodiment of this invention, the process illustrated by the flowchart of FIG. 10.

The change detecting process is started, as in the first embodiment of this invention, when one of the management servers 104 and one of the application servers 105 exchange a packet through the management network 102.

The processes performed in Step 801 to Step 804 are similar to those in Step 501 to Step 504 of the first embodiment of this invention shown in FIG. 8.

After a program for receiving the packet is specified in Step 804, it is determined, with reference to the protocol and the port number of the packet, whether the payload 406 of the packet needs to be referred to (Step 805).

Specifically, in a case where it is determined that the received packet is an HTTP packet based on a combination of the protocol and the destination port of the packet, it is determined that the payload 406 needs to be referred to.

In a case where it has been determined in Step 805 that the payload 406 does not need to be referred to, the process proceeds to Step 806. In and after Step 806, the process follows the processes similar to the processes performed in and after Step 505 of the first embodiment of this invention shown in FIG. 8.

As regards the HTTP packet having the payload 406 that has been determined to be referred to, it is determined whether the payload 406 of the HTTP packet includes a specific message (Step 807).

Specifically, in a case where the payload 406 of the HTTP packet does not include a SOAP message, the process is ended because configuration information is not to be changed. Also, even in a case where the payload 406 of the HTTP packet includes the SOAP message, the process is ended because configuration information is not to be changed as long as the SOAP message is the resource operation Get of the WS-Transfer. On the other hand, in a case where the payload 406 includes the SOAP message and the SOAP message is other than the resource operation Get of the WS-Transfer, it is determined that configuration information is likely to be changed. Also, configuration information collection targets includes all programs operating on the application server 105, and the process proceeds to Step 810.

Next, the configuration information collecting module 112 is instructed to collect configuration information from all the programs operating on the application server 105 (Step 810).

The processes performed in Step 811 to Step 814 thereafter are similar to those in Step 509 to Step 512 of the first embodiment of this invention shown in FIG. 8.

The fifth embodiment of this invention enables the management server 104 to determine whether the configuration information of a program operating on a specific application server 105 is highly likely to have been changed, by using WS-Management. Then, in a case where it is determined that the configuration information is highly likely to have been changed, configuration information of all the programs operating on the specific application server 105 is collected, which allows the application administrator to be informed of what kind of change has been made to the configuration information.

### Sixth Embodiment

Hereinbelow, a description is given of a sixth embodiment of this invention, which is a modification of the fifth embodiment of this invention.

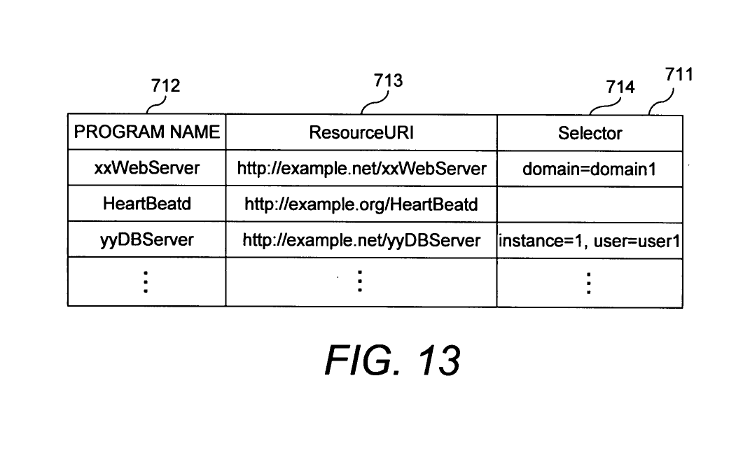

FIG. 13 shows a changing WS-Management definition table 711 stored in the storage device 113 to be used in the sixth embodiment of this invention.

The changing WS-Management definition table 711 is used for specifying a program name defining a program whose configuration information is to be changed, based on a ResourceURI and a Selector.

The changing WS-Management definition table 711 stores therein program names 712, Resource URIs 713, and Selectors 714.

The program names 712 are program names defining programs which are exclusively subjected to change of configuration information by the WS-Management message.

The Resource URIs 713 are identifiers for identifying the programs based on the WS-Management message. The Selectors 714 are also identifiers for identifying the programs based on the WS-Management message. Since one WS-Management message includes 0 or more Selector elements 709, one record of the Selectors 713 includes 0 or more pairs of a Selector name and a Selector value.

According to the sixth embodiment of this invention, in a case where the SOAP message is other than the resource operation Get of the WS-Transfer in Step 807 of the fifth embodiment of this invention, the process proceeds to Step 808. It should be noted that, a line showing flow from Step 807 to Step 808 is not shown in FIG. 10.

Next, values of the Resource URI element 708 and the Selector element 709 included in the HTTP packet are compared with the values of Resource URI 713 and the Selector 714 in the changing WS-Management definition table 711 (Step 808).

As a result of the comparison, in a case where there is a record which includes the Resource URI element 708 and the Selector element 709 which have values corresponding to the values of the Resource URI 713 and the Selector 714, the configuration information collecting module 112 is instructed to collect configuration information only from programs corresponding to the program names 712 of the corresponding record (Step 809). On the other hand, in a case where the changing WS-Management definition table 711 does not include a corresponding record, the configuration information collecting module 112 is instructed to collect configuration information from all the programs operating on the application server 105 which is a destination of the packet (Step 810).

The processes performed in Step 811 to Step 814 thereafter are similar to those in Step 509 to Step 512 of the first embodiment of this invention shown in FIG. 8.

The sixth embodiment of this invention enables the management server 104 to determine whether the configuration information of a program operating on a specific application server 105 is highly likely to have been changed, by using WS-Management. Then, in a case where it is determined that the configuration information is highly likely to have been changed, configuration information of all the programs operating on a specific one of the application servers 105 is collected, which allows the application administrator to be informed of what kind of change has been made to the configuration information.

While the present invention has been described in detail and pictorially in the accompanying drawings, the present invention is not limited to such detail but covers various obvious modifications and equivalent arrangements, which fall within the purview of the appended claims.

What is claimed is:

1. A change detecting method of detecting a change in configuration information of an application server installed in a computer system,
the computer system including: one or more of the application servers; a management server for controlling the application servers; and a configuration management server for managing configuration information of the application servers,
the change detecting method comprising:
a first step of obtaining a packet transmitted from the management server to at least one of the application servers;
a second step of specifying at least one of the application servers which receives the obtained packet and at least one of resources on the application servers, with reference to the configuration information held by the configuration management server by using the obtained packet; and
a third step of determining whether configuration information of the resources on the application servers is likely to be changed by an operation of the specified resource.

2. The change detecting method according to claim 1, wherein the second step includes referring the configuration information held by the configuration management server by using at least one of: a service name obtained from the destination IP address of the packet and the destination port number of the packet; and a destination IP address of the packet and a destination port number of the packet.

3. The change detecting method according to claim 1, wherein the third step includes determining whether the configuration information is likely to be changed by using at least one of: the resources on the application servers; a destination port number of the packet; a service name obtained from the destination port number; and information included in a payload of the packet.

4. The change detecting method according to claim 1, further comprising a fourth step of specifying, based on the configuration information which is determined to be likely to be changed, at least one of the resources on the application servers which is likely to be changed by the operation of the specified resource, and determining whether the configuration information of the specified resource is likely to be changed.

5. The change detecting method according to claim 4, wherein the fourth step includes determining whether the configuration information of the specified resource is likely to be changed by using at least one of: the resources on the application servers; a destination port number of the packet; a service name obtained from the destination port number; and information included in a payload of the packet.

6. The change detecting method according to claim 1, further comprising a fifth step of collecting the configuration information of a resource on the specified application server,
wherein the fifth step includes avoiding instructing the application servers from which configuration information is being collected to further collect configuration information.

7. The change detecting method according to claim 1, further comprising a fifth step of collecting configuration information of the resources on the specified application servers,
wherein the fifth step includes stopping, in a case of periodically collecting the configuration information from the application servers, the collecting process of the configuration information.

8. A change detecting device for detecting a change in configuration information of an application server installed in a computer system,
the computer system including: one or more of the application servers; a management server for controlling the application servers; and a configuration management server for managing configuration information of the application servers,
the change detecting device comprising:
a management packet obtaining module for obtaining a packet transmitted from the management server to at least one of the application servers, and specifying at least one of the application servers which receives the obtained packet, and at least one of resources on the application servers, with reference to the configuration information held by the configuration management server by using the obtained packet; and
a configuration change occurrence determining module for determining whether configuration information of the resource on the application server is likely to be changed by an operation of the specified resource.

9. The change detecting device according to claim 8, wherein the management packet obtaining module refers the configuration information held by the configuration management server by using at least one of: a service name obtained from the destination IP address of the packet and the destination port number of the packet and a destination IP address of the packet and a destination port number of the packet.

10. The change detecting device according to claim 8, wherein the configuration change occurrence determining module determines whether the configuration information is likely to be changed by using at least one of: the resources on the application servers; a destination port number of the packet; a service name obtained from the destination port number; and information included in a payload of the packet.

11. The change detecting device according to claim 8, further comprising a changed resource specifying module for specifying, based on the configuration information which is determined to be likely to be changed, at least one of the resources on the application servers which is likely to be changed by the operation of the specified resource, and determining whether the configuration information of the specified resource is likely to be changed.

12. The change detecting device according to claim 11, wherein the changed resource specifying module determines whether the configuration information of the specified resource is likely to be changed by using at least one of: the resources on the application servers; a destination port number of the packet; a service name obtained from the destination port number; and information included in a payload of the packet.

13. The change detecting device according to claim 8, further comprising a configuration information collecting module for collecting the configuration information of a resource on the specified application server, wherein, the configuration information collecting module avoids instructing the application servers from which configuration information is being collected to further collect configuration information.

14. The change detecting device according to claim 8, further comprising the configuration information collecting module for collecting configuration information of the resources on the specified application servers,
wherein the configuration information collecting module stops, in a case of periodically collecting the configuration information from the application servers, the collecting process of the configuration information.
